(19) United States
(12) Patent Application Publication
(10) Pub. No.: US 2012/0237692 A1
(43) Pub. Date: Sep. 20, 2012

(54) EFFECTIVE COATING METHOD FOR PLATE TYPE NANO MATERIALS ON LARGE AREA SUBSTRATE

(76) Inventors: Jae Do NAM, Seoul (KR); Joon Suk Oh, Seoul (KR); Tae Seon Hwang, Seoul (KR)

(21) Appl. No.: 13/418,732

(22) Filed: Mar. 13, 2012

(30) Foreign Application Priority Data
Mar. 14, 2011 (KR) 10-2011-0022465

(51) Int. Cl. B05D 1/18; C09D 5/00; B05D 3/02; B05D 3/00; B05D 3/10

(52) U.S. Cl. 427/532; 427/372.2; 427/299; 106/1.25

(57) ABSTRACT

A method for coating a substrate with a plate type nanomaterial is provided. The method involves preparing a dispersed solution containing the plate type nanomaterial and a surface active agent, dipping the substrate into the dispersed solution, and drying the substrate after withdrawing the substrate from the dispersed solution. Also provided herein are a dipping solution used for coating the substrate, and a method of preparing a dipping solution for coating a substrate with a plate type nanomaterial.

### CROSS-REFERENCE TO RELATED APPLICATION(S)

This application claims the benefit under 35 U.S.C. §119(a) of Korean Patent Application No. 10-2011-0022465 filed on Mar. 14, 2011, in the Korean Intellectual Property Office, the entire disclosure of which is incorporated herein by reference for all purposes.

### BACKGROUND

1. Field

The following description relates to a method for coating a substrate with a plate type nanomaterial. The description also relates to a method of coating a plate type nanomaterial on a large-scaled substrate uniformly and quickly through a dipping process by controlling various process conditions, to a method of preparing the dipping solution by manufacturing the plate type nanomaterial through breaking up the stack structure of a nanomaterial, and to a dipping solution used to coat the plate type nanomaterial.

2. Description of Related Art

Recently, nanomaterials with excellent thermal, mechanical and electrical properties have been subject to many studies. Nanomaterials have various applications because they have high electron mobility and remarkable mechanical flexibility. To use nanomaterials in these applications, nanomaterials may be coated on the substrate through a coating process.

However, for nanomaterials that have a stack structure containing dozens to hundreds of layers, the stack structure needs be broken down first to make a single layer of thin film of plate type nanomaterials before the nanomaterials are coated on a substrate. Thus, coating nanomaterials on a large-scaled substrate could be accompanied by very complicated processes.

Regarding the approaches in making thin film with nanomaterials, it is known that a thin film of small particles may be obtained at an interface between a solution and air. This approach is known as Langmuir-Blodgett method (LB method). But because the LB method uses weak Van der Waals forces between particles or between particles and a substrate, the ratio of transition to a substrate on a large-scaled substrate is low. Thus, it is difficult to make a large uniform thin film using the LB method.

It is also known that raw materials prepared in a gas form can be used to coat a nanomaterial directly on a substrate possible through a gaseous reaction to deposit and grow nanomaterials, as in the pyrolysis method, laser fusion method, chemical gas state deposition method and the like. However, even with these methods, it is still difficult to coat a single layer film uniformly on a large-scaled substrate, and there are many problems associated with trying to coat a single layer film uniformly using these processes.

On the other hand, it is known that to have a thin film coated with graphene, which is a plate type nanomaterial from graphite, a graphene dispersed solution is first prepared, and a graphene thin film is formed by a vacuum filtering process and coated on a substrate (see J H Lee, D W Shin et al., Adv. Mater, 2009, 21, 1-5).

However, in these methods, the coating size is determined by the filter size used when the graphene dispersed solution is vacuum filtered. Therefore, this technique is limited to coat a plate type nanomaterial on a small-scaled substrate.

### SUMMARY

In one general aspect, there is provided a method for coating a substrate with a plate type nanomaterial. The method may involve preparing a dispersed solution containing the plate type nanomaterial and a surface active agent, dipping the substrate into the dispersed solution, and drying the substrate after withdrawing the substrate from the dispersed solution.

The plate type nanomaterial used in the method may be selected from the group consisting of graphene, boron nitride and montmorillonite. The surface active agent used in the method may be selected from the group consisting of sodium dodecylbenzenesulfonate, sodium dodecyl sulfate and a combination thereof.

The method for coating a substrate with a plate type nanomaterial may also involve hydrophilically modifying a surface of the substrate by a plasma treatment or by the surface active agent.

The concentration of the dispersed solution of the plate type nanomaterial used with the method may range from 10 wt % to 70 wt %. The temperature of the dispersed solution of the plate type nanomaterial used in the method may range from 60° C. to 150° C.

The drying of the substrate may be performed under a temperature condition of 25° C. to 95° C. The drying of the substrate may be performed under a relative humidity condition of 10% to 30%.

During the withdrawing of the substrate, a withdrawal rate ranging from 0.001 mm/s to 0.1 mm/s may be used. The withdrawal angle of the substrate from the dispersed solution during the withdrawing of the substrate may range from 5° to 40°.

In another aspect, there is provided a dipping solution for coating a substrate with a plate type nanomaterial. The dipping solution may include a solvent, a plate type nanomaterial dispersed in the solvent, and a surface active agent dispersed in the solvent.

The surface active agent in the dipping solution may be selected from the group consisting of sodium dodecylbenzenesulfonate, sodium dodecyl sulfate and a combination thereof. The concentration of the plate type nanomaterial in the dipping solution may range from 10 wt % to 70 wt %. The plate type nanomaterial may be selected from the group consisting of graphene, boron nitride and montmorillonite.

In yet another aspect, there is provided a method for preparing a dipping solution for coating a substrate with a plate type nanomaterial. The method may involve obtaining a plate type nanomaterial by breaking stacks of layers of a source nanomaterial into single layered thin films, and dispersing the plate type nanomaterial in a solvent with a surface active agent.

The surface active agent may be selected from the group consisting of sodium dodecylbenzenesulfonate, sodium dodecyl sulfate and a combination thereof. The plate type nanomaterial in the dipping solution may be mono-layered graphene sheets. In another example, the plate type nanomaterial may be selected from the group consisting of graphene, boron nitride and montmorillonite.

The concentration of the plate type nanomaterial in the dipping solution may range from 10 wt % to 70 wt %.

Throughout the drawings and the detailed description, unless otherwise described, the same drawing reference numerals will be understood to refer to the same elements, features, and structures. The relative size and depiction of these elements may be exaggerated for clarity, illustration, and convenience.

### BRIEF DESCRIPTION OF THE DRAWINGS

FIG. 1 is a SEM image showing natural graphite as a typical nanomaterial.

FIG. 2 is a SEM image showing interlayer-expanded graphite obtained using a microwave method according to one example.

FIG. 3 is a schematic diagram illustrating one example of a method of combining a surface active agent to a plate type nanomaterial.

FIG. 4 is a schematic diagram illustrating one example of a method of combining a surface active agent to a substrate.

FIG. 5 is a schematic diagram illustrating one example of a withdrawal process of a substrate from a dispersed solution containing a plate type nanomaterial.

FIG. 6 is a schematic diagram further illustrating the example of the withdrawal process of the substrate from a dispersed solution containing the plate type nanomaterial.

FIG. 7 is a cross-sectional view of an example substrate on which a plate type nanomaterial is coated.

### DETAILED DESCRIPTION

The following detailed description is provided to assist the reader in gaining a comprehensive understanding of the methods, compositions, apparatuses, and/or systems described herein. Accordingly, various changes, modifications, and equivalents of the systems, apparatuses, compositions and/or methods described herein will be suggested to those of ordinary skill in the art. Also, descriptions of well-known functions and constructions may be omitted for increased clarity and conciseness.

Provided herein is a method for coating a substrate with a plate type nanomaterial that makes it possible to coat a plate type nanomaterial on the large-scaled substrate uniformly and easily. The method may use a dipping process. The dipping solution may be prepared by adding a plate type nanomaterial and a surface active agent after obtaining the plate type nanomaterial by breaking up the stack structure of the nanomaterial.

One example of the coating method involving the steps of preparing a dispersed solution containing the plate type nanomaterial and surface active agent, dipping the substrate into the dispersed solution and drying the substrate after withdrawing the substrate from the dispersed solution.

Also provided is a method for coating a substrate with a plate type nanomaterial, which makes it possible to coat a plate type nanomaterial on a large-scaled substrate uniformly by using a dipping process, after a dispersed solution of the plate type nanomaterial is prepared by breaking up the stack structure of a nanomaterial.

In addition, by adjusting various process conditions such as temperature, humidity, speed of moving the substrate upward and the like during the dipping process, the plate type nanomaterial can be coated uniformly on a large-scaled substrate.

Unless defined differently, the technical or scientific terms used in this specification have the same meaning as generally understood by those skilled in the art. The terms used herein should be interpreted as the same meaning generally used in dictionaries, or in a technical or scientific references of the same field.

In one general aspect, a method for coating a substrate with a plate type nanomaterial may involve the steps of preparing a dispersed solution containing the plate type nanomaterial and surface active agent, dipping the substrate into the dispersed solution and drying the substrate after withdrawing the substrate from the dispersed solution.

First, a dispersed solution containing a plate type nanomaterial and a surface active agent may be prepared. A plate type nanomaterial is a thin single-layer film (i.e., monolayer sheet) which is made by breaking down the stack structure of dozens to hundreds of layers. For example, graphene, boron nitride, montmorillonite, and the like can be a plate type nanomaterial.

Graphene is a single-layer material that may be removed from graphite with a carbon hexagonal honeycomb structure. Boron nitride has a chemical formula of B—N and a hexagonal stack structure that is similar to the structure of graphite. Montmorillonite is a typical clay mineral and consists of a dual layer of silica tetrahedra structure and a single layer of giddsite octahedral structure, in the ratio of 2:1 and each particle is plate type with 1 μm of mean diameter. Therefore, to uniformly coat the above nanomaterial on substrate, a single layer thin film of plate type nanomaterial should be prepared by breaking down the stacked layer structure.

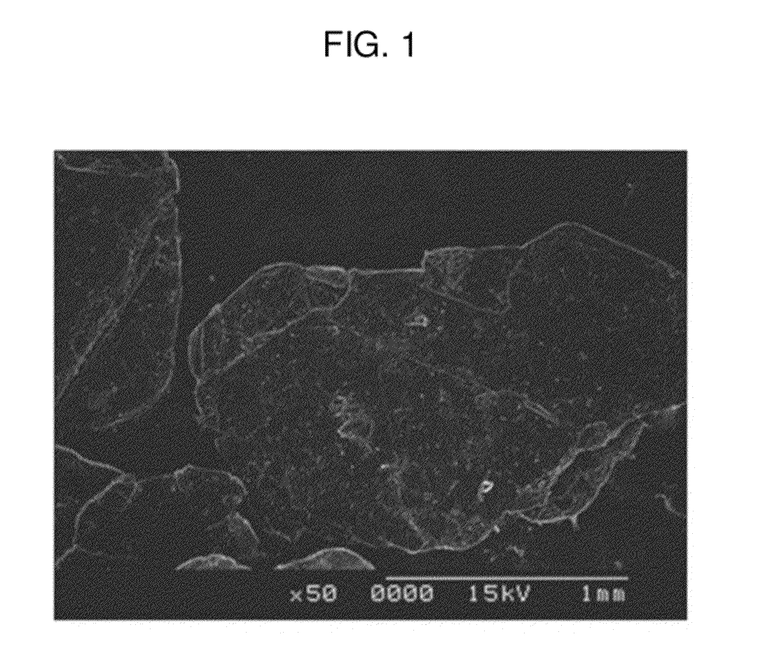

FIG. 1 is a SEM image of natural graphite as a typical nanomaterial.

According to FIG. 1, nanomaterials like graphite have a stacked structure with dozens to hundreds of layers. To prepare a uniformly-dispersed solution, the stacked structure nanomaterials should be broken down into a single layer thin film of plate type nanomaterial.

First, to break down the stacked structure, each layer may be expanded to make more room in the interlayer. A microwave process can be used for the interlayer expansion. The microwave process may involve radiating a microwave in the range of 2,000 to 3,000 MHz on the nanomaterial. To expand the interlayer, H₂SO₄ may be added to the nanomaterial. The H₂SO₄ infiltrates into each interlayer of nanomaterial to expand the interlayer.

If the nanomaterial is radiated with a microwave, oscillations occur at a molecular level of the nanomaterial, and the vibration energy is converted into thermal energy. Sulfuric acid that infiltrates between the layers of the nanomaterial is gasified to break away. The interlayer of nanomaterial is expanded in the course of intercalation.

The process can be performed in the air. However, it is preferred to be performed in an inert gas atmosphere like N₂, Ar, He and the like. Asides from the microwave process, the plate type nanomaterial can also be prepared by a thermal treatment for seconds at a high temperature to expand the interlayer of the nanomaterial.

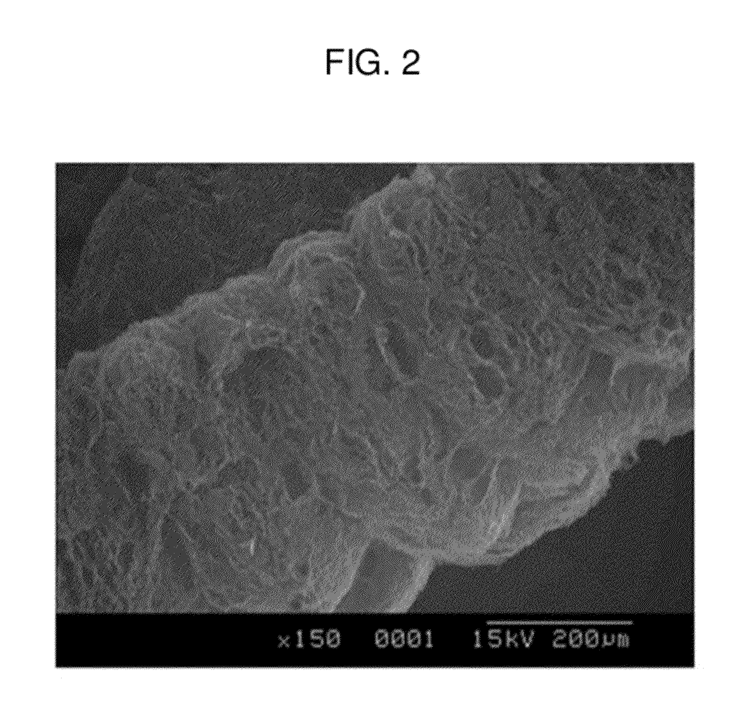

FIG. 2 is a SEM image of a interlayer-expanded graphite through a microwave method according to one example.

As illustrated in FIG. 2, the natural graphite interlayer may be expanded horizontally by applying the microwave method.

Afterwards, a solvent and a surface active agent may be added to the plate-type nanomaterial whose interlayer has been expanded to have a chemical surface treatment.

A polar solvent may be used as the solvent. The polar solvent can be a solution that dissolves and stabilizes one or more polar compounds. The polar solvent may contain one or more of water, alcohols, acetone, liquid ammonia and the like. However, the polar solvents that can be used are not limited to the above mentioned examples.

At this time, the solvent and surface active agent may be added together. As a surface active agent, SDBS (sodium dodecylbenzenesulfonate) or SDS (sodium dodecyl sulfate) can be used to make an O— group at the end of graphene, which maximizes the adhesion and bonding to the substrate when coating with dipping.

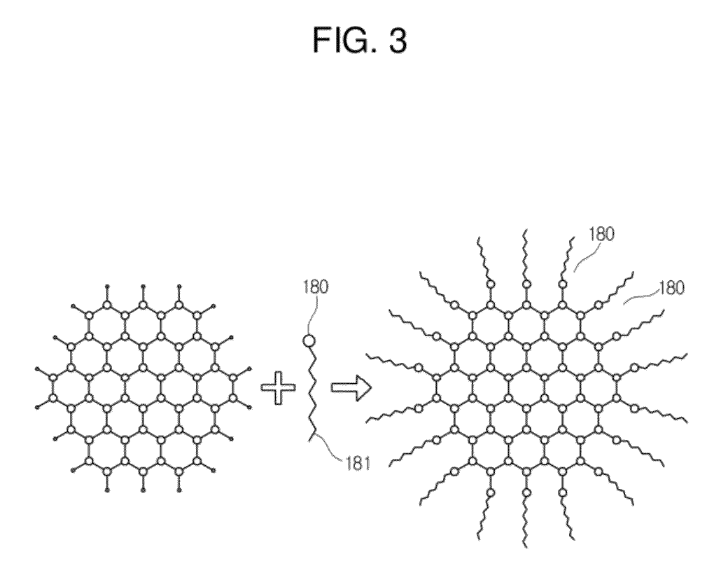

FIG. 3 illustrates an example of a method by which the surface active agent may be combined to the plate type nanomaterial.

In FIG. 3, the nanomaterial interlayer is expanded and the surface active agent is combined around the perimeter of the prepared plate type nanomaterial.

Afterwards, the dispersed solution of the plate type nanomaterial is prepared by exfoliating the plate type nanomaterial that went through the above process. The dispersion process may use centrifugation, milling and the like. However, considering uniform dispersibility of raw material, it is preferred to use ultrasonic waves in order to disperse on an ultrafine nano scale. In this example, the dispersed solution of plate type nanomaterial with surface active agent is prepared through the use of ultrasonic wave.

As an example of a manufacturing process of a dispersed solution containing plate type nanomaterial 101 and surface active agent 180, graphite may be laminated with graphene as a typical nanomaterial. The graphite may be mixed with H₂SO₄ and K₂SO₄ and left for 3-5 minutes. Then, it may be radiated for several minutes at 600˜800W of microwave in a microwave oven. The interlayer of graphite is expanded by the above process. The graphite whose surface treatment was finished may be sonicated under several hundreds of watt (W) in the solution in which the surface active agent is added to expand the interlayer to make the graphene dispersed solution. Considering the following dip coating process, the concentration of graphene dispersed solution prepared may preferably be from 10 wt % to 70 wt %. That is, the concentration of nanomaterial in the graphene dispersed solution may range from 10 wt % to 70 wt %. The temperature of graphene dispersed solution can range between the freezing point and the boiling point, and can preferably range from 60° C. to 150° C. The substrate can be dipped into the graphene dispersed solution at these temperature ranges.

Afterwards, the substrate is dipped into the dispersed solution of plate type nanomaterial, and the dip coating process where plate type nanomaterial is coated on substrate may be performed. The substrate may be then withdrawn from the solution and dried.

The dip coating process is a process performed to dip the substrate to be coated into a coating solution or slurry and thereafter withdrawing the substrate from the coating solution or the slurry. When withdrawn, the coating agent is coated on the surface of the substrate to be coated. The layer can be coated uniformly regardless of the material or the form of the substrate to be coated. This has the effect of reducing the loss of coating solution. Also, there may be no limit on the type of substrate that can be coated. Different substrates can be used regardless of whether the substrate contains glass, silicon, plastic and the like, or whether the glass, silicon, plastic and the like included in the substrate is thermally safe or not.

Before performing the dipping process, the substrate may be subjected to a step of treating the surface of the substrate to increase its bonding and adhesion to nano particles present in the dispersed solution of the plate type nanomaterial.

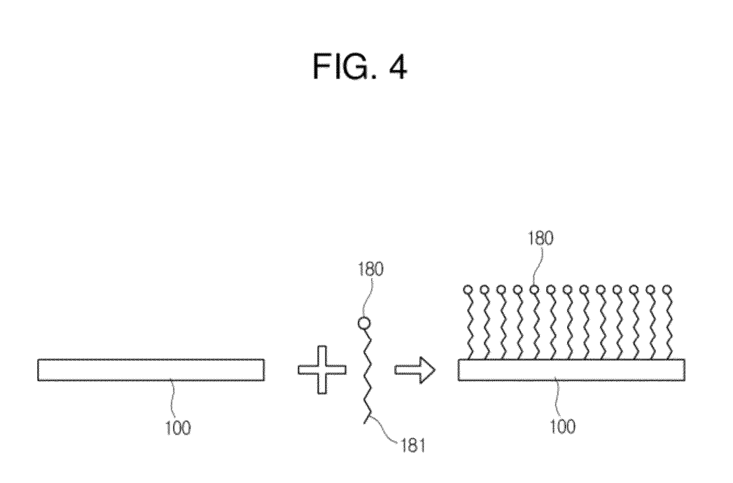

FIG. 4 illustrates how the surface active agent may be combined to the substrate according to one example.

In FIG. 4, the hydrophobic group 181 of the surface active agent 180 may be bonded to (adhered to) the substrate 100. The surface active agent 180 may use cationic polymer surface active agent, poly ethylene glycol type surface active agent, and the like, which may be selected from polyethyleneimine, poly(sodium styrenesulfonate), poly(acrylic acid), poly(N-vinyl-2-pyrrolidone), poly(allylamine hydrochloride), poly(diallyldimethylammonium chloride), diazoresin. Besides, a plasma treatment can be used when treating the surface of the substrate 100. When using plasma physically, the oxygen, hydrogen, nitrogen, argon or a mixture of these gases may be used.

The surface treatment of the substrate 100 improves the wetting properties of polar solvent by changing the hydrophobic surface of the substrate 100 to be hydrophilic. If the surface of the substrate is hydrophilic, the above step of surface treatment can be omitted.

After the substrate to be coated is dipped into the dispersed solution of plate type nanomaterial, the substrate may be withdrawn or removed from the solution and subsequently dried.

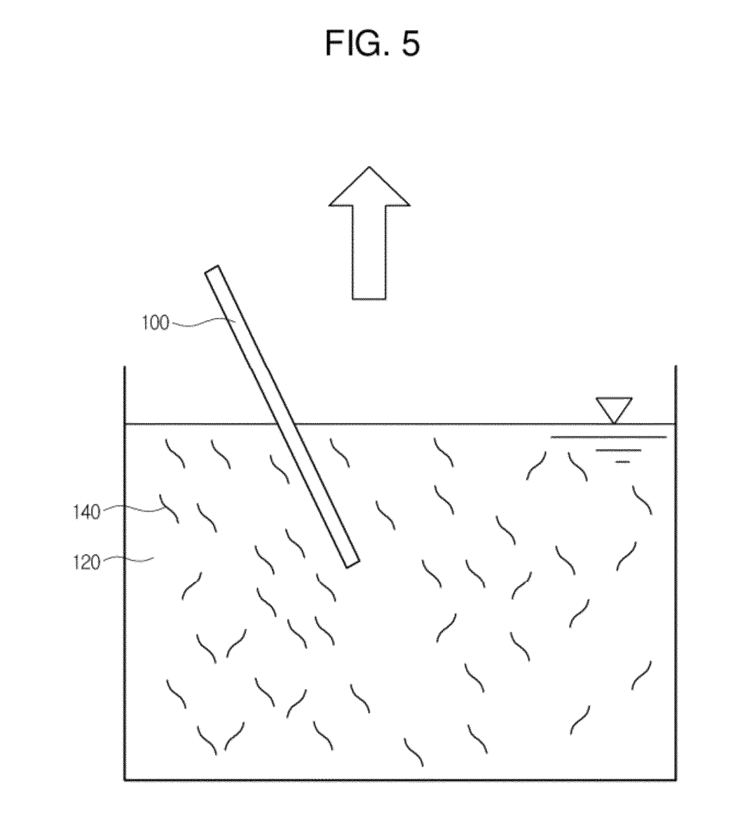

FIG. 5 illustrates an example of the withdrawal process of the substrate 100 from dispersed solution 120 of plate type nanomaterial.

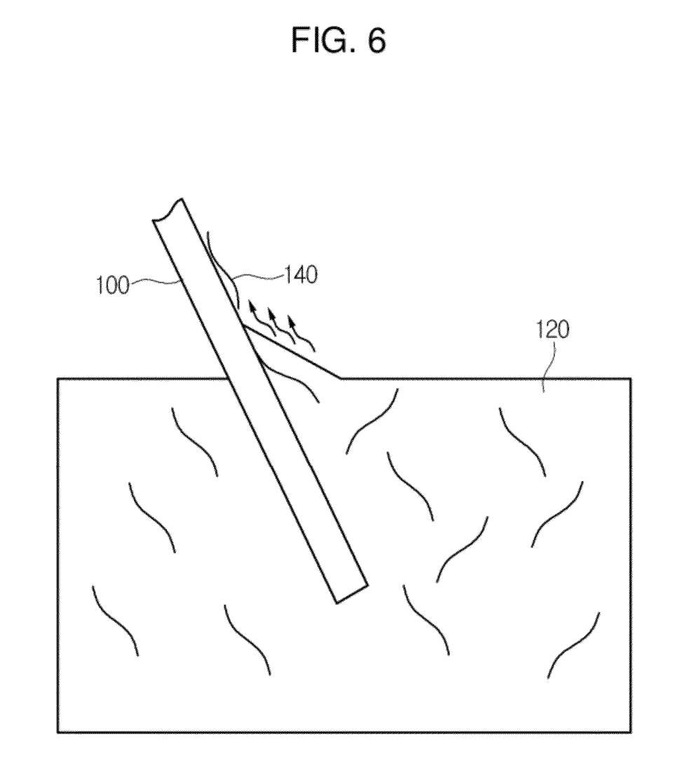

FIG. 6 further illustrates the example of the withdrawal process of the substrate 100 from dispersed solution 120 of plate type nanomaterial.

In FIGS. 5 and 6, the surface-treated substrate 100 is dipped into the dispersed solution 120 of plate type nanomaterial prepared. Using dip coater 140, the substrate 100 is withdrawn from the dispersed solution 120 of plate type nanomaterial, moving upward at a speed of 0.001 mm/s to 0.1 mm/s. By the above step, plate type nano particles 140 which exist in dispersed solution 120 of plate type nanomaterial are bonded to (adhered to) the surface of the substrate 100 and the solvent is evaporated. The concentration of the dispersed solution of plate type nanomaterial preferably ranges from 10 wt % to 70 wt %. If the concentration is less than 10 wt %, it may be difficult to make a uniform coating film. If the concentration is more than 70 wt %, the substrate can be over coated, creating a crack during the drying process. Further, it may be difficult to form a dense coating.

The withdrawing angle is preferably from 5° to 40° and the speed of moving upward is preferably from 0.001 mm/s to 0.1 mm/s. If the speed of moving upward is less than 0.001 mm/s, it is not effective to coat plate type nano particle 140 on the substrate 100. If the speed of moving upward is more than 0.1 mm/s, it may be difficult to coat uniformly. The temperature of coating process preferably ranges from 25° C. to 95° C., and the relative humidity preferably ranges from 10% to 30%. The lower the relative humidity, the faster the evaporation of the solvent at a point the substrate 100 and the dispersed solution 142 of plate type nanomaterial meet to enable a coating to be effective.

Finally, the withdrawn substrate coated with plate type nanomaterial is dried. It can be dried in an oven, but the method of drying is not limited thereto and various drying methods such as a heater drying method with a dip coating apparatus can be used.

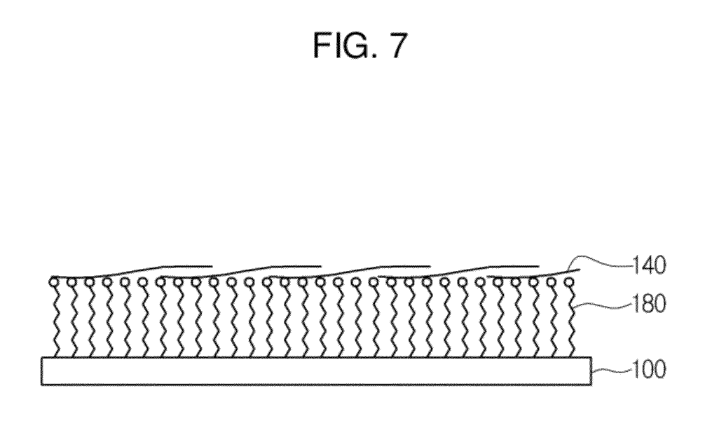

FIG. 7 illustrates a cross sectional view of the substrate on which a plate type nano particle 140 is coated using the above described process.

In FIG. 7, in the dip coating process, by controlling the process conditions, it is possible to coat a thin and uniform coating film on the substrate with a remarkable property.

Coating of plate type nanomaterial has been an object of many current studies. The above described examples of coating methods can be applied to a large-scaled substrate. Further, by controlling the temperature, ascending speed, relative humidity and the like, the above described methods can coat a coating film on the substrate with remarkable uniformity.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for coating a substrate with a plate type nanomaterial, the method comprising:
preparing a dispersed solution containing the plate type nanomaterial and a surface active agent;
dipping the substrate into the dispersed solution; and
drying the substrate after withdrawing the substrate from the dispersed solution.

2. The method for coating a substrate with a plate type nanomaterial according to claim 1, wherein the plate type nanomaterial is selected from the group consisting of graphene, boron nitride and montmorillonite.

3. The method for coating a substrate with a plate type nanomaterial according to claim 1, wherein the surface active agent is selected from the group consisting of sodium dodecylbenzenesulfonate, sodium dodecyl sulfate and a combination thereof.

4. The method for coating a substrate with a plate type nanomaterial according to claim 1, wherein a surface of the substrate is hydrophilic ally modified by a plasma treatment or the surface active agent.

5. The method for coating a substrate with a plate type nanomaterial according to claim 1, wherein a concentration of the dispersed solution of the plate type nanomaterial ranges from 10 wt % to 70 wt %.

6. The method for coating a substrate with a plate type nanomaterial according to claim 1, wherein a temperature of the dispersed solution of the plate type nanomaterial ranges from 60° C. to 150° C.

7. The method for coating a substrate with a plate type nanomaterial according to claim 1, wherein the drying of the substrate is performed under a temperature condition of 25° C. to 95° C.

8. The method for coating a substrate with a plate type nanomaterial according to claim 1, wherein the drying of the substrate is performed under a relative humidity condition of 10% to 30%.

9. The method for coating a substrate with a plate type nanomaterial according to claim 1, wherein a withdrawal rate of the substrate during the withdrawing of the substrate ranges from 0.001 mm/s to 0.1 mm/s.

10. The method for coating a substrate with a plate type nanomaterial according to claim 1, wherein a withdrawal angle of the substrate from the dispersed solution during the withdrawing of the substrate ranges from 5° to 40°.

11. A dipping solution for coating a substrate with a plate type nanomaterial, the solution comprising:
a solvent;
a plate type nanomaterial dispersed in the solvent; and
a surface active agent dispersed in the solvent.

12. The dipping solution for coating a substrate with a plate type nanomaterial according to claim 11, wherein the surface active agent is selected from the group consisting of sodium dodecylbenzenesulfonate, sodium dodecyl sulfate and a combination thereof.

13. The dipping solution for coating a substrate with a plate type nanomaterial according to claim 11, wherein a concentration of the plate type nanomaterial in the dipping solution ranges from 10 wt % to 70 wt %.

14. The dipping solution for coating a substrate with a plate type nanomaterial according to claim 11, wherein the plate type nanomaterial is selected from the group consisting of graphene, boron nitride and montmorillonite.

15. A method for preparing a dipping solution for coating a substrate with a plate type nanomaterial, the method comprising:
obtaining a plate type nanomaterial by breaking stacks of layers of a source nanomaterial into single layered thin films; and
dispersing the plate type nanomaterial in a solvent with a surface active agent,
wherein the surface active agent is selected from the group consisting of sodium dodecylbenzenesulfonate, sodium dodecyl sulfate and a combination thereof.

16. The method for preparing a dipping solution for coating a substrate with a plate type nanomaterial according to claim 15, wherein the plate type nanomaterial comprises mono-layered graphene sheets.

17. The method for preparing a dipping solution for coating a substrate with a plate type nanomaterial according to claim 15, wherein the plate type nanomaterial is selected from the group consisting of graphene, boron nitride and montmorillonite.

18. The method for preparing a dipping solution for coating a substrate with a plate type nanomaterial according to claim 15, wherein a concentration of the plate type nanomaterial in the dipping solution ranges from 10 wt % to 70 wt %.
